(19) United States
(12) Patent Application Publication
(10) Pub. No.: US 2011/0251889 A1
(43) Pub. Date: Oct. 13, 2011

(54) INVENTORY CLUSTERING

(75) Inventors: Patrice Y. Simard, Bellevue, WA (US); David M. Chickering, Bellevue, WA (US); Denis X. Charles, Bellevue, WA (US)

(73) Assignee: MICROSOFT CORPORATION, Redmond, WA (US)

(21) Appl. No.: 12/757,634

(22) Filed: Apr. 9, 2010

(51) Int. Cl. G06Q 30/00; G06Q 10/00

(52) U.S. Cl. 705/14.43; 705/14.46

(57) ABSTRACT

Various embodiments provide techniques for inventory clustering. In one or more embodiments, a set of inventory to be processed is placed into an initial cluster. The inventory can be related to impressions for advertising that are defined by values for a set of attributes. Recursive division of the initial cluster is performed by selecting an attribute and deriving child clusters that are constrained by one or more values of the attributes in accordance with one or more clustering algorithms. The clustering algorithms are configured to derive an optimum number of clusters by repetitively generating smaller child clusters and measuring a cost associated with adding additional clusters. Additional child clusters can be formed in this manner until the measured cost to add more clusters outweighs a benefit of adding more clusters.

### BACKGROUND

In display advertising for online resources, advertisers make orders targeted to specific customers which are matched to inventory which represents attributes of the customers (e.g., impressions) defined by the orders. Allocation of the orders to the inventory is a complex constraint satisfaction problem, which is can be computationally expensive to solve precisely for large numbers of available inventories (e.g., billions every day) and/or large numbers of advertiser orders (tens of thousands) that can be associated with a service provider. When approximations are made to simplify the allocation problem and obtain an allocation solution, the approximations can cause a loss of revenue due to advertisers being unable to achieve impression goals associated with their orders. Inefficient allocation can also prevent a service provider from selling all of the inventory the service provider has available. In this context, the service provider can be concerned with optimizing matching of various orders from advertisers to inventory/impressions in a manner that maximizes revenue and fulfills all the orders.

As noted, though, inventory matching of this type can become quite difficult as the number of advertisers and/or impressions to be matched becomes larger due to the number of computations involved in performing the matching. Thus, traditional algorithms suitable to perform matching with relatively small data sets may be unable to successfully perform matching for larger data sets that arise in some scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide techniques for inventory clustering. In one or more embodiments, a set of inventory to be processed is placed into an initial cluster. The inventory can be related to impressions for advertising that are defined by values for a set of attributes. Recursive division of the initial cluster is performed by selecting an attribute and deriving child clusters that are constrained by one or more values of the attributes in accordance with one or more clustering algorithms. The clustering algorithms are configured to derive an optimum number of clusters by repetitively generating smaller child clusters and measuring a cost associated with adding additional clusters. Additional child clusters can be formed in this manner until the measured cost to add more clusters outweighs a benefit of adding more clusters.

### BRIEF DESCRIPTION OF THE DRAWINGS

FIG. 1 illustrates an example operating environment in which one or more embodiments of inventory clustering can be employed.

FIG. 2 is a flow diagram that describes an example procedure in accordance with one or more embodiments.

FIG. 3 is a diagram that depicts an example of inventory clustering in accordance with one or more embodiments.

FIG. 4 is a flow diagram that describes another example procedure in accordance with one or more embodiments.

FIG. 5 is a diagram that depicts another example of inventory clustering in accordance with one or more embodiments.

FIG. 6 is a block diagram of a system that can implement the various embodiments.

### DETAILED DESCRIPTION

### Overview

Various embodiments provide techniques for inventory clustering. In one or more embodiments, a set of inventory to be processed is placed into an initial cluster. The inventory can be related to impressions for advertising that are defined by values for a set of attributes. Recursive division of the initial cluster is performed by selecting an attribute and deriving child clusters that are constrained by one or more values of the attributes in accordance with one or more clustering algorithms. The clustering algorithms are configured to derive an optimum number of clusters by repetitively generating smaller child clusters and measuring a cost associated with adding additional clusters. Additional child clusters can be formed in this manner until the measured cost to add more clusters outweighs a benefit of adding more clusters.

In the discussion that follows, a section entitled “Operating Environment” describes but one environment in which the various embodiments can be employed. Following this, a section entitled “Inventory Clustering Procedures” describes example techniques for inventory clustering in accordance with one or more embodiments. Next, a section entitled “Inventory Clustering Implementation Details” describes example algorithms and implementations for inventory clustering in accordance with one or more embodiments. Last, a section entitled “Example System” is provided and describes an example system that can be used to implement one or more embodiments.

Operating Environment

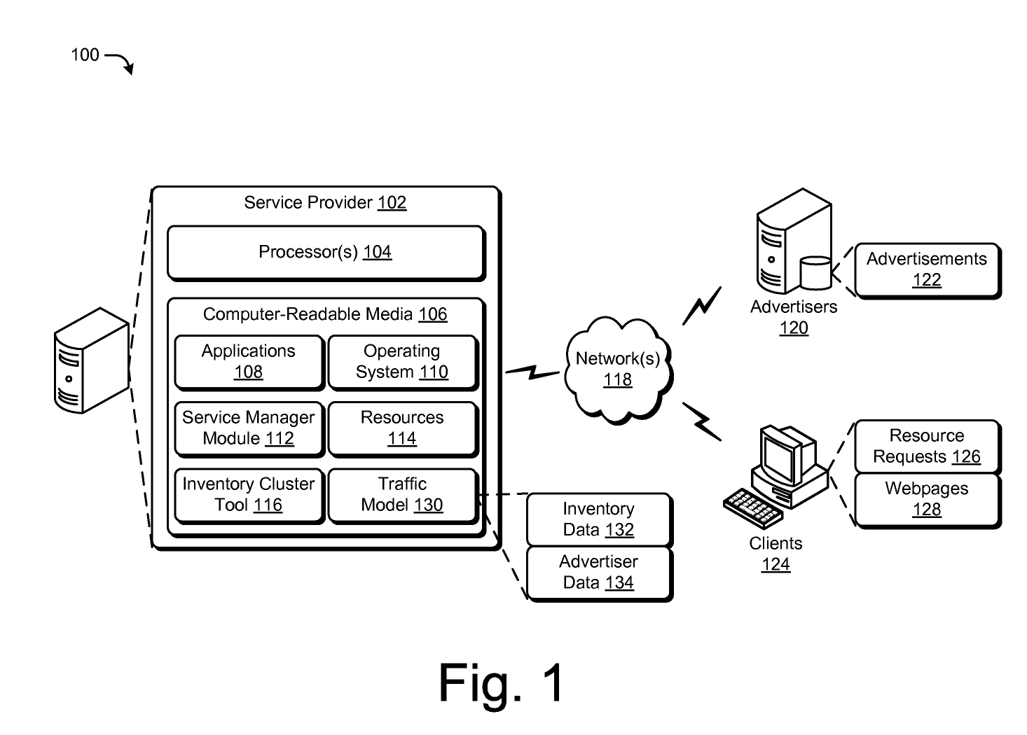

FIG. 1 illustrates an operating environment in accordance with one or more embodiments, generally at 100. Environment 100 includes a service provider 102 having one or more processors 104, one or more computer-readable media 106 and one or more applications 108 that are stored on the computer-readable media and which are executable by the one or more processors 104. The computer-readable media 106 can include, by way of example and not limitation, all forms of volatile and non-volatile memory and/or storage media that are typically associated with a computing device. Such media can include ROM, RAM, flash memory, hard disk, optical disks, removable media, and the like. Computer-readable media 106 is also depicted as storing an operating system 110, a service manager module 112, resources 114 (e.g., content, services, and data), and an inventory cluster tool 116 that may also be executable by the processor(s) 104. While illustrated separately, the inventory cluster tool 116 may also be implemented as a component of the service manager module 112.

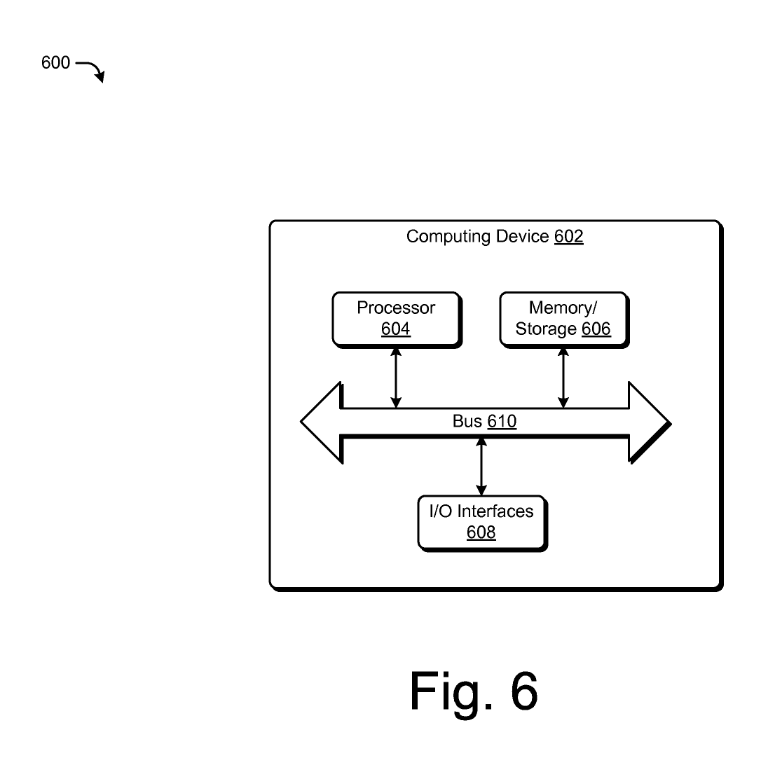

Service provider 102 can be embodied as any suitable computing device or combination of devices such as, by way of example and not limitation, a server, a server farm, a peer-to-peer network of devices, a desktop computer, and the like. One specific example of a computing device is shown and described below in relation to FIG. 6. Service provider 102 can be communicatively coupled over a network 118 to various other entities (e.g., devices, servers, storage locations, clients, and so forth). In particular, service provider 102 is illustrated as being connected over the network 118 to advertisers 120 that provide advertisements 122 and clients 124. Advertisers 120 and clients 124 may interact over the network 118 with the service provider 102 to obtain access to various resources 114. Although the network 118 is illustrated as the Internet, the network may assume a wide variety of configurations. For example, the network 118 may include a wide area network (WAN), a local area network (LAN), a wireless network, a public telephone network, an intranet, and so on. Further, although a single network 118 is shown, the network 118 may be configured to include multiple networks.

Service manager module 112 represents functionality operable by service provider 102 to manage various resources 114 that may be made available over the network 118. Service manager module 112 may manage access to the resources 114, performance of the resources 114, configuration of user interfaces or data to provide the resources 114, and so on. For example, clients 124 may form resource requests 126 for communication to the service provider 102 to obtain corresponding resources 114. In response to receiving such requests, service provider 102 can provide various resources 114 via webpages 128 and/or other user interfaces that are communicated over the network 118 for output by the one or more clients 124.

Resources 114 can include any suitable combination of content and/or services typically made available over a network by one or more service providers. Content can include various combinations of text, video, ads, audio, multi-media streams, animations, images, and the like. Some examples of services include, but are not limited to, a search service, an email service to send and receive email, an instant messaging service to provide instant messages between clients, and a social networking service to facilitate connections and interactions between groups of users who share common interests and activities. Services may also include an advertisement service configured to enable advertisers 120 to place advertisements 122 for presentation to clients 104 in conjunction with the resources 114.

For instance, at least some of the webpages 128 can be configured to include advertisements 122 provided by the advertisers 120. Advertisements 122 may be selected for inclusion in webpages through an advertisement service using any suitable techniques for selection and delivery of the ads. In one example, auctions may be conducted for space that is reserved in a webpage 128 for advertisements 122 from the advertisers 120. Further, booking of orders for ads and delivery of the ads may occur in accordance with inventory cluster techniques described herein.

The inventory cluster tool 116 is configured to implement aspects of inventory clustering techniques described herein. The techniques can be employed in the context of clustering inventory that relates to impressions used to deliver advertising space reserved in webpages 128 or other resources 114 to advertisers 120. To perform clustering, the inventory cluster tool 116 may be configured to make use of a traffic model 130 that represents various data related to interaction of the service provider 102 with clients 124 and/or advertisers 120, and that may be collected, stored, and/or accessed via the service provider 102. Although the example traffic model 130 of FIG. 1 is illustrated as being stored on computer-readable media 106 of the service provider 102, it is contemplated that traffic model 130 may be compiled, stored, and/or obtained by way of any suitable local or network storage location and/or device. In the example of FIG. 1, the traffic model 130 is illustrated as including inventory data 132 and advertiser data 134.

Inventory data 132 can include data related to client interaction with the service provider 102 such as search queries input through a search service, page views, click patterns, keyword statistics, and so forth. Inventory data 132 can also include impressions that are defined by one or more keywords that relate to clients 124, activities of the clients 124, and/or properties of the clients 124. For example, keywords identified based on a search query such a search for “ESPN” may be used to match advertisements to webpages 128 based on the keywords. In this case the keyword “Sports,” as well as other keywords, may be associated with the search for “ESPN.” A client account that is used to perform the search may also be a source of keywords that relate to demographics, such as locations, genders, and/or ages of a user that initiates the search. In this context, an order may target a set number of impressions that relate to selected keywords, such as one hundred thousand impressions related to “Sports” and “Male.” Advertiser data 134 can include data describing actual and/or simulated orders for impressions from advertisers 120, as well as bids for ad auctions, advertisement delivery schedules, and so forth.

More particularly, the inventory cluster tool 116 represents functionality operable to at least obtain data describing inventory and/or impressions and apply one or more clustering algorithms to form clusters of the inventory. In at least some embodiments, the inventory cluster tool 116 is configured to cluster inventory to optimize an objective function that measures the cost associated with adding more clusters. The inventory cluster tool 116 may be implemented to enable inventory clustering through offline simulations using the traffic model 130 and/or online using actual traffic (e.g., actual orders and impressions). Further discussion of clustering techniques that may be implemented by way of the inventory cluster tool 116 can be found in relation to the following figures.

Having considered an example operating environment, consider now a discussion of example inventory clustering techniques in accordance with one or more embodiments.

Inventory Clustering Procedures

The following discussion describes inventory clustering techniques that may be implemented utilizing the environment, systems, and/or devices described above and below. Aspects of each of the procedures below may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference may be made to the example environment 100 of FIG. 1.

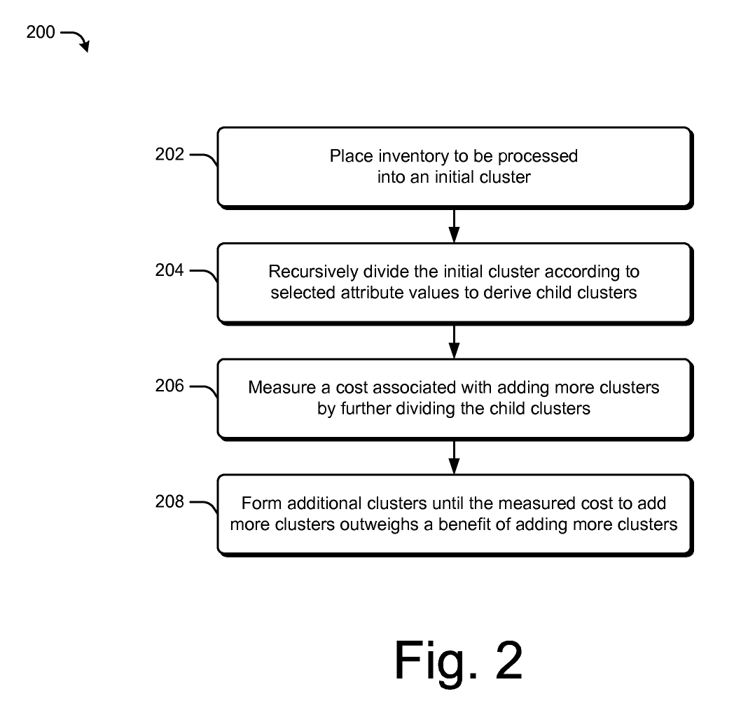

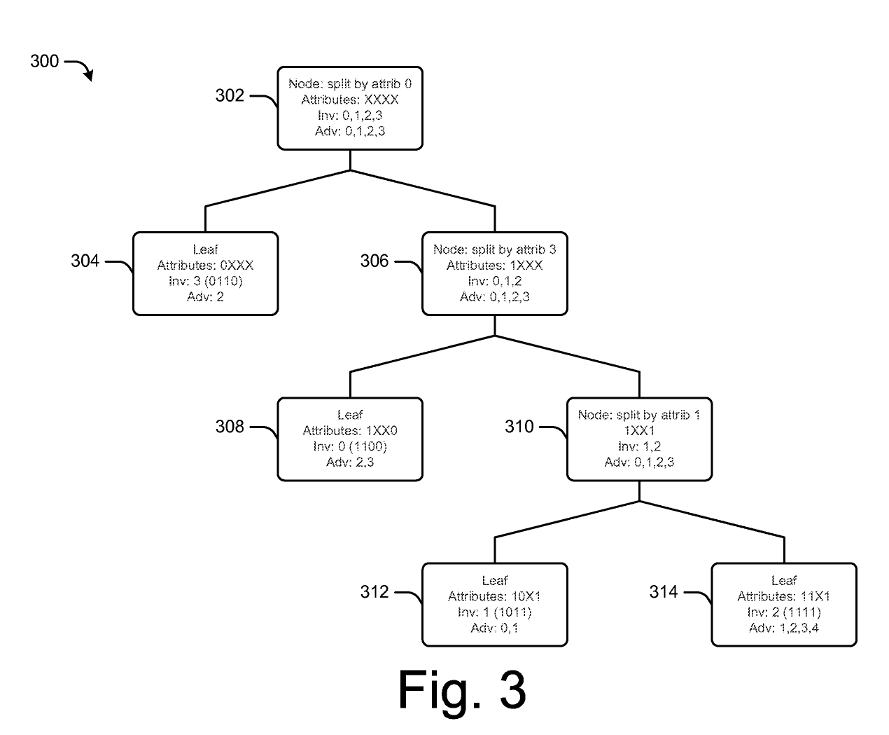

FIG. 2 is a flow diagram that describes an example procedure 200 in accordance with one or more embodiments. In at least some embodiments, the procedure 200 can be performed by a suitably configured computing device, such as a service provider 102 of FIG. 1, or other computing device having an inventory cluster tool 116. In the course of discussing procedure 200, reference may be made to the example clustering depicted in FIG. 3.

Step 202 places inventory into an initial cluster. One way this can occur is by operation of inventory cluster tool 116 to obtain inventory data 132 that may be included as part of a traffic model 130 of a service provider 130. Additionally or alternatively, inventory cluster tool 116 can be configured to receive data describing inventory from any suitable source. The inventory can include various impressions having corresponding combinations of attributes.

Advertisers 120 can place orders for impressions by designating very specific combinations of attributes. For example, orders from advertisers may target attribute combination such as “Male; 35-45 years of age; interested in sports” or “User who have visited web page x; have not visited page y; have made a purchase of type z in the last n days.” Mixing the various attributes associated with inventory produces an exponential number of combinations of attributes. Attributes can include binary attributes that can have two values (e.g., gender male or female) and/or attributes that can have many different values (e.g., an age attribute that has five age categories). The inventory on which the designated impressions can potentially be delivered have values for each of the attributes associated with the orders. This creates a set of constraints defined by the order. To fulfill an order, the order is matched based on the constraints to inventory and/or impressions that satisfy the constraints.

In the interest of simplicity, various examples of clustering as discussed herein are described in terms of binary attributes that can have two values, such as yes/no, on/off, true/false, and so forth. It is trivial, though, to generalize these examples to attributes that can have more than two values. Clusters that are divided using attributes that can have multiple values n can be divided to form a corresponding number n of child clusters. Thus, the inventory clustering techniques described herein can be applied to an arbitrary number of attributes and arbitrary number of values per attributes. More generally, a cluster can be split based on various subsets of the possible values for an attribute. As an example, if there are seven values for a particular attribute a cluster could be split into three child clusters having corresponding values (0, 3, 5), (1, 2, 6), (4, 7) for the particular attribute. Note that the value for the particular attribute in this example is not uniquely defined for the child clusters. In other examples, a complete split could be made such that a value for the particular attribute is uniquely defined for each child cluster. Thus a cluster can be divided in a complete or a partial manner with respect to a particular attribute.

By way of example, assume that there are four attributes labeled 0 through 3. These example attributes could be such things as “has kids” or “is over 65.” Assume further that each of the attributes is a binary attribute that can have two values, 0 or 1. Additionally, there may be four orders from advertisers each targeting a specific combination of the attributes. For instance, a first advertiser may request 500 impressions with the pattern 1XX1. Here, the pattern 1XX1 indicates that attribute 0 is designated as 1, attribute 1 and 2 are unspecified, and attribute 3 is designated as 1. The X's here are wildcards that indicate the value for the attribute is not specified. A second advertiser may request 200 impressions with attributes designated by XXX1. Here the second advertiser has designated a value of attribute 3 as 1 and has not specified a value for attributes 0, 1, and 2. In at least some embodiments, the value of 0 can be reserved for use by a service provider 102 to indicate that a value of an attribute is unknown for particular inventory. Accordingly, advertisers may use 1's and X's as just described to designate combinations of attributes for orders.

As noted, inventory that is available through a service provider 102 also has associated constraints. For the inventory of the service provider 102, attributes can be associated with states, such as by using values of 0, 1, or 2 for a three state variable. The inventory is also associated with a corresponding number of impressions that can be delivered (e.g., availability). This is summarized by the following example in Table 1 below:

TABLE 1
Example Inventory-Order Match Matrix

| | | | Advertisers | | | |
|---|---|---|---|---|---|---|
| | | Requested | 500 | 200 | 100 | 400 |
| | | Price | $100 | $200 | $10 | $500 |
| | | Order | 1XX1 | XXX1 | X1XX | 11XX |
| | | Constraints | | | | |
| | | Inventory | | | | |
| | Available | Constraints | | | | |
| Service Provider | 1000 | 1100 | | | match | match |
| | 600 | 1011 | match | match | | |
| | 100 | 1111 | match | match | match | match |
| | 100 | 0110 | | | match | |

Recall that “X” can be used by an advertiser to indicate that the advertiser does not care about the value for a particular attribute. On the side of a service provider 102, X can be used to denote that impressions associated with particular inventory can have different states/values for the denoted attribute. For example, inventory designated as 1XXX indicates that the first attribute has a value of 1 and the remaining attributes can have different values for different impressions in the inventory. Thus, in at least some embodiments, the symbol X can be used for an attribute value associated with inventory when there are at least two different values for the corresponding attribute in the inventory. For example, clusters of inventory from Table 1 could be represented with the X notation using three clusters as follows:
11XX (available=1000+100=1100)
10XX (available=600)
01XX (available=100)

The advertiser constraints can be matched by matching each attribute to corresponding inventory constraints. Again, X for the advertiser is a wild card that can match any value. For instance and order 1XX1 can match inventory 1011 because X can match either 0 or 1. When X is also employed on the inventory side, an order X can also match an X that is associated with inventory. When an advertiser order designates a particular value (0, 1, 2, etc.) for an attribute, though, this can match a corresponding value (0, 1, 2, etc.) for inventory, but does not match an inventory X. The idea is that a designated value matches for each impression in the inventory. For example, an order value of 1 does not match an X for inventory because the X indicates that there are at least two different values for the corresponding attribute at least one of which is not a 1.

The allocation problem using the foregoing representations can then be formulated as a linear problem for finding a matrix M={m_{i,j}} which fulfills the constraints on the sums of columns and rows. An example allocation matrix corresponding to Table 1 above is as follows:

TABLE 2
Example Allocation Matrix

| | =500 | =200 | =100 | =400 |
|---|---|---|---|---|
| ≦1000 | 0 | 0 | m_{0,2} | m_{0,3} |
| ≦600 | m_{1,0} | m_{1,1} | 0 | 0 |
| ≦100 | m_{2,0} | m_{2,1} | m_{2,2} | m_{2,3} |
| ≦100 | 0 | 0 | m_{3,2} | 0 |

For small data sets, the linear problem defined above is not complex and can be readily solved using traditional techniques such as LP (linear programming), POCS (projection onto convex sets), and so forth. The complexity and time associated with solving such problems, though, can be proportional to the number of inventory constraints times the number of advertiser constraints. For service providers that can have inventory in multiple billions and orders from advertisers in the tens of thousands, traditional techniques can be too inefficient and slow to adequately allocate the inventory to the advertisers. Accordingly, inventory clustering techniques described herein can be employed to form smaller clusters of inventory and advertisers that can make the allocation faster and less computationally expensive.

To do so, the inventory cluster tool 116 can be configured to initially place the inventory into the same initial cluster. For this initial cluster, there may not be constraints on attributes that are associated with the inventory. For instance, in the example above having four attributes the initial cluster may be designated as XXXX. Inventory cluster tool 116 may then operate to perform clustering techniques to divide the initial cluster into smaller clusters using various clustering algorithms.

In particular, step 204 recursively divides the initial cluster according to selected attribute values to derive child clusters. The inventory cluster tool 116 can be configured to selectively designate values for attributes to form child clusters that have different values for a selected attribute. In at least some embodiments, the inventory cluster tool 116 operates to select an attribute and create a different child cluster for each possible value of the attribute. For instance, if the example attribute labeled 0 is selected, child clusters corresponding to 0XXX and 1XXX can be formed. Inventory is then divided into the child clusters such that inventory placed into a cluster matches the constraints of the cluster. Each child cluster can then selectively be divided further by specifying values in a similar manner for one or more other attributes. As discussed above and below, determining whether or not to further divide the child clusters can be based upon a measured cost associated with dividing the clusters.

FIG. 3 depicts generally at 300 an example cluster graph corresponding to the above example. An initial cluster 302 is illustrated that has attribute values XXXX. The initial cluster 302 is divided into a cluster 304 designated by attribute values 0XXX and a cluster 306 designated by attribute values 1XXX. The cluster 306 is illustrated as being further divided in a like manner into additional sub-clusters including cluster 308, cluster 310, cluster 312 and cluster 314. Naturally, cluster 304 could also be further divided to form another branch of clusters in the tree structure that is illustrated in FIG. 3.

This tree depicted in FIG. 3 can be computed recursively by starting at the initial cluster and dividing the inventory into child clusters by attribute value until the inventory can no longer be split. In this case, the child clusters that are formed at the end of branches become leaves, and the sub-set of inventory placed into respective leaves are indistinguishable one to another. Each distinct sub-set of the inventory (e.g., combination of attributes) appears in exactly one leaf. Advertisers can also follow the attribute tree. Since the advertisers have wild cards, though, the advertisers can appear in multiple paths and leaves.

The tree is said to be “pruned” at a child cluster, if a determination is made not to further divide the child cluster when further dividing is possible. If the tree is pruned, the child cluster becomes a leaf which represents a cluster of the inventory. If the tree has no pruning (e.g., division occurs to expand the tree until no further separation is possible), the final set of leaves has the optimal potential for displaying advertisers. In this case, the sequence in which the attributes are split has no impact on the final solution. If the tree is pruned, though, the sequence used to perform division affects the cluster leaves and how many displaying opportunities each advertiser will have.

Forming of clusters of inventory as just described can continue recursively until an objective defined for the clustering has been met. In at least some embodiments, the objective corresponds to a cost associated with forming the clusters. Accordingly, step 206 measures a cost associated with adding more clusters by further dividing the child clusters. For instance, inventory cluster tool 116 may be implemented to apply various suitable techniques and/or objective functions to measure a cost associated with further dividing a set of clusters. The cost that is measured can be dependent upon a change in opportunities to match advertisers to impressions that results when a cluster is divided. As noted, the initial cluster can be unconstrained with respect to attribute values. Dividing a cluster can increase opportunities to match advertisers to impressions in the child clusters. In other words the potential for advertisers to have their ads displayed can be increased. The increase in matching opportunities is offset by costs that are associated with forming the clusters. Suitable objective function can be designed to account for these as well as other considerations.

In at least some embodiments, suitable objective functions are defined that are configured to (1) measure revenue opportunity for a given cluster (2) determine a potential revenue assuming the cluster is divided into smaller clusters, and (3) calculate a cost to divide the cluster as a difference between the determined potential revenue and the measured revenue opportunity. A variety of different objective functions that may be employed to implement inventory clustering are discussed in greater detail in the relation to the following figures.

Step 208 forms additional clusters until the measured cost to add more clusters outweighs a benefit of adding more clusters. In other words, inventory cluster tool 116 may operate to continue to form smaller and smaller clusters until a cost analysis indicates that the objective defined for the clustering is at an optimum. Various performance metrics including but not limited to revenue, costs, processing time, orders fulfilled and so forth can be employed individually or in combination to perform the cost analysis.

For instance, cost analysis can indicate that expected revenue has reached a designated amount and/or that creation of additional clusters decreases revenue. Additionally or alternatively, inventory cluster tool 116 can operate to form clusters according to a configurable threshold for the difference between measured revenue and potential revenue. So long as the difference is greater than the threshold, the inventory cluster tool 116 can be configured to continue to form additional clusters. When the difference is not greater than the threshold, the inventory cluster tool 116 can be configured to complete the clustering and output a set of clusters as a result of the clustering.

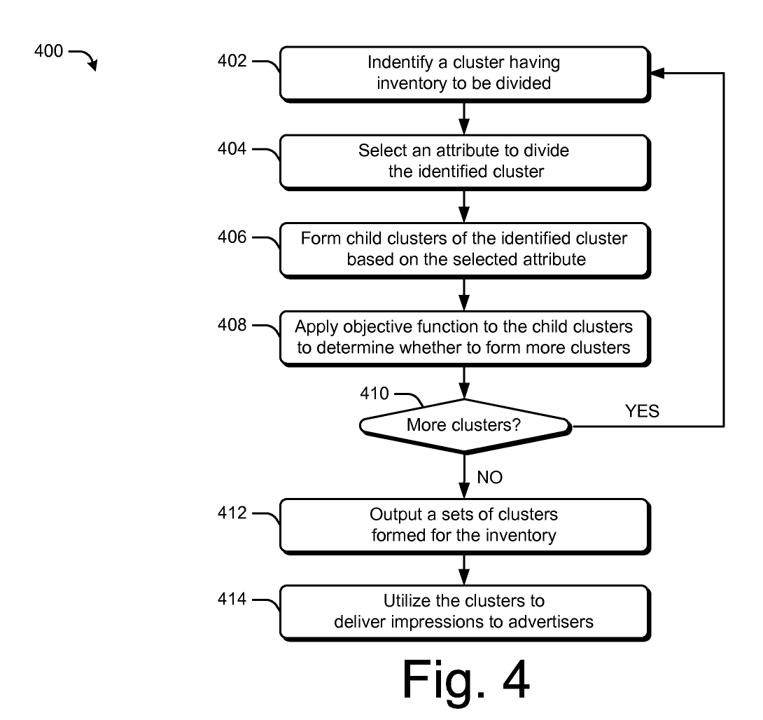

FIG. 4 is a flow diagram that describes another example procedure 400 in accordance with one or more embodiments. In at least some embodiments, the procedure 400 can be performed by a suitably configured computing device, such as a service provider 102 of FIG. 1, or other computing device having an inventory cluster tool 116.

Step 402 identifies a cluster having inventory to be divided. One way this can occur is through operation of the inventory cluster tool 116 to determine inventory and/or clusters to be divided recursively using multiple iterations. For a first iteration, the identified cluster can correspond to an initial cluster that is configured to contain an initial set of inventory to be processed. The initial cluster can be un-constrained with respect to values for attributes of the inventory. In successive iterations, different child clusters and branches can be processed in turn. These iterations can involve placing different constraints on inventory with respect to different child clusters by specifying values for attributes of the inventory associated with the clusters. The iterations can result in division of the initial inventory into a plurality of clusters.

Step 404 selects an attribute to divide the identified cluster, and step 406 forms child clusters of the identified cluster based on the selected attribute. For example, inventory cluster tool 116 can operate to select an attribute from multiple attributes, resolve values for the attribute, and produce child clusters that correspond to different values that can be assigned to the selected attribute. This can occur repetitively for different attributes.

Attributes that are used for inventory clustering can be selected in any suitable way. In at least some embodiments, attributes can be selected randomly. Additionally or alternatively, attributes can be pre-ranked to produce a predefined and/or configurable list of rankings for the attributes. Attributes can then be selected by applying the rankings each time a parent cluster is divided. Still further, a heuristic can be defined that enables weighting of attributes dynamically each time a parent cluster is divided. This attribute weighting can be based at least in part upon an assessment of potential advertiser revenue corresponding to each attribute. Details regarding these and other aspects of selecting attributes for inventory clustering can be found below in a section entitled “Inventory Clustering Implementation Details.”

Step 408 applies an objective function to the child clusters to determine whether to form more clusters. For instance, inventory cluster tool 116 can be implemented to apply one or more objective functions individually and/or in various combinations. A variety of suitable objective functions are contemplated, examples of which are discussed in detail in the following section under the heading “Example Objective Functions.”

Step 410 makes a determination regarding whether or not to create more clusters. As noted this determination can involve determining when a cost to add more clusters outweighs a benefit of adding more clusters. When it is determined to create more clusters in step 410, procedure 400 returns to step 402 where another target cluster is identified to divide. Steps 404 to 408 are then repeated for the target cluster that is identified in the manner just described. Thus, the objective function can be applied and reapplied in multiple iterations to determine whether or not to form more clusters.

When it is determined not to create more clusters in step 410, procedure 400 proceeds to step 412. Step 412 outputs a set of clusters that are formed for the inventory. The set of cluster can be represented in any suitable way. For instance, the clusters can be represented graphically such as in a graph similar to the example graph 300 of FIG. 3. Clusters can also be expressed descriptively using a text file, data file, or other suitable output that describes the clusters.

Step 414 utilizes the clusters to deliver impressions to advertisers. In particular, the clusters formed in the manner described herein can be used to allocate impressions to advertisers 120. Since individual clusters contain less inventory and correspond to fewer advertisers, it can be faster and less computationally expensive to match inventory and advertisers (e.g., orders) one to another using the clusters.

Having described example procedures involving inventory clustering, consider now specific implementation examples that can be employed with one or more embodiments described herein.

Inventory Clustering Implementation Details

Consider now a discussion of example inventory clustering algorithms and implementation details that may be employed using the previously described devices and systems. As may now be apparent to the reader, an objective of inventory clustering can be to partition the inventory into a small number of mutually exclusive clusters, while maximizing the number of opportunities that exist between advertisers and the clusters.

### Example Objective Functions

To maximize display opportunities and/or revenue, generally the size of clusters into which a set of inventory is divided can be kept relatively large. As a partition over the inventory, the clusters are disjoint and encompass the whole inventory space. The clusters are formed to have a set of common values for a subset of the attributes that enable a large number of advertisers to be displayed over the sub-set of inventory placed in the cluster. Such large clusters can be employed for inventory allocation in lieu of fragmenting the inventory completely to reduce computational expense and improve performance. As discussed above, clusters can be computed by starting with inventory to be processed being placed into one cluster and dividing the inventory by attribute recursively. Forming of clusters can occur until a cost of adding more clusters outweighs a benefit of enabling more advertisers to display in the clusters.

To achieve this, costs and/or benefits of subdividing a cluster can be estimated using an objective function. A variety of objective functions can be defined that are suitable for the inventory clustering techniques described above and below. In the discussion that follows some general characteristics of such objective functions are first described. Thereafter, the discussion turns to a description of some example objective functions.

Generally speaking, suitable objective functions are defined to measure one or more performance metrics associated with forming additional clusters. Various performance metrics including but not limited to revenue, costs, processing time, orders fulfilled, and so forth can be employed individually or in combination to perform this analysis.

More particularly, example properties and characteristic of suitable objective functions can include the following:
The cluster objective function F(C) evaluated at a cluster C measures the sum of the potentials for each advertiser to monetize on this cluster and/or performance improvements based on one or more performance metrics. The sum S(C)=Σ_{Lε{leaves under C}}F (L) over all cluster leaves under cluster C is the global measure to optimize.
For a given tree, the objective function is linear with respect to each advertiser orders and/or price. This provides independence between advertiser contributions. Advertisers can be incrementally added or removed in any order on a given tree without affecting the contribution to the objective function of the remaining advertisers.
The objective function is strictly monotonic (e.g., increasing) when a cluster is subdivided by an attribute. This provides progress guarantees with each cluster division.
The objective function does not change if a cluster is subdivided by an attribute but additional opportunities for advertisers are not created. This prevents the unnecessary creation of clusters.
An (over) estimate G(C) of the global objective function S(C) can be computed top down and efficiently. G(C) is strictly decreasing with respect to cluster division.

In at least some embodiments, objective functions are defined using performance metrics including at least revenue values related to the clusters. In this example, objective functions can be configured to (1) measure revenue opportunity for a given cluster (2) determine a potential revenue assuming the cluster is divided into smaller clusters, and (3) calculate a cost to divide the cluster as a difference between the determined potential revenue and the measured revenue opportunity.

For the purposes of deriving clusters of inventory, allocation and double counting issues can be ignored. Given a set of clusters, solving the allocation using traditional techniques is relatively straightforward as mentioned previously. Thus, clustering as described herein can be considered a preparation step for solving the allocation problem. Ignoring allocation constraints for the purpose of deriving clusters simplifies the problem considerably and makes inventory clustering for large amounts of inventory and numbers of advertisers tractable.

For the description of example objective functions that follows assume each cluster C is characterized by the following attributes:
A set of inventory. Let I₀, I₁, . . . , I_{ΔN-1}} represent the number of impressions Iᵢ for inventory i.
A set of attributes B_{C}={(Tₖ,Vₖ)}, (attribute, value) pair, that is common to inventory in cluster C.
A set of advertiser order: A₀, A₁, . . . , A_{{M-1}}. For each advertiser Aⱼ, define:
   Pⱼ as a price of the order Aⱼ.
   Rⱼ as a number of impression requested for the order.
MatchSet(C)=set of indices j for which Aⱼ matches the common attributes{(Tₖ,Vₖ)}.

One example revenue opportunity function is to compute the revenue opportunity at a leaf by counting the possible matches. At a given child cluster, consider the sum of the inventory that matches for attributes of the child cluster that have been defined. The unexplored attributes are set to 0. Now, evaluate the advertisers that match the inventory. For instance, consider an example cluster C with one type of inventory and two advertisers that match the attributes of the inventory:
Inventory: I₀=200 impressions
Advertiser A₀: 50 impressions, $50. P₀=50, R₀=50
Advertiser A₁: 300 impressions, $100. P₁=100, R₁=300

Given the foregoing, now consider some example objective functions suitable for use with the described inventory clustering techniques. For each function discussed below, a description is given followed by an example computation using the function and the example cluster C just described.

A first example objective function F is configured to compute a total number of impression opportunities times a price per impression for each advertiser. The definition and example computation for F are as follows:

$$F ( C ) = ( {\sum }_{i ∈ C} {I}_{i} ) * ( {\sum }_{j ∈ MatchSet ( C )} \frac{{P}_{j}}{{R}_{j}} )$$

$$200 Imps * ( \$1 . \text{/} Imps + \$0 .33 \text{/} Imp ) = \$266 .66$$

A detailed analysis of the objective function F above is provided following a description of some other example objective functions. As shown in the detailed analysis, F meets the general criteria for a suitable objective function as set forth in the preceding discussion.

Another example objective function F1 is configured to compute a total impression opportunity. This assumes that each advertiser impression can be displayed in any of the available inventory impressions. The definition and example computation for F1 are as follows:

F1(C)=(Σ_{iεC}Iᵢ)*(Σ_{jεMatchSet(C)R}ⱼ)

200*350=70000

Although F1 can be suitably employed in one or more embodiments, it is noted that F1 may not accurately capture the price of orders.

Another example objective function F2 is configured to compute impression opportunities for each advertiser that are capped for each advertiser. In other words, impression opportunities for an advertiser are capped by the available inventory. The definition and example computation for F2 are as follows:

F2(C)=Σ_{jεMatchSet(C)}min(Σ_{iεC}Iᵢ,Rⱼ)

min(200,50)+min(200,300)=250

Although F2 can be suitably employed in one or more embodiments, it is noted that F2 may not strictly adhere to some of the criteria for a suitable objective function as set forth above. The objective function F2 increases when a child cluster is split even when no new opportunities are created. For instance, if the child cluster is split by another attribute into two clusters of 100 inventories, the bottom up sum of opportunities would increase to (min(100,50)+min(100,300))+(min(100,50)+min(100,300))=300.

Another example objective function F4 is configured to compute the value of F1 in a manner that is capped globally. The definition and example computation for F4 are as follows:

$$F 4 ( C ) = min ( {\sum }_{i ∈ C} {I}_{i} , {\sum }_{j ∈ MatchSet ( C )} {R}_{j} ) * ( {\sum }_{j ∈ MatchSet ( C )} \frac{{P}_{j}}{{R}_{j}} )$$

$$min ( 200 , 350 ) * ( \$1 . \text{/} Imps + \$0 .33 \text{/} Imp ) = \$266 .66$$

Another example objective function F5 is configured to compute a number of impression opportunities times a price per impression that are capped for each advertiser. The definition and example computation for F5 are as follows:

$$F 5 ( C ) = {\sum }_{j ∈ MatchSet ( C )} min ( {\sum }_{i ∈ C} {I}_{i} , {R}_{j} ) * \frac{{P}_{j}}{{R}_{j}}$$

$$min ( 200 , 50 ) * \$1 + min ( 200 , 300 ) * \$0 .33 = \$116 .66$$

Another example objective function F6 is configured to compute a capped number of impressions times a global average price per impression. The definition and example computation for F6 are as follows:

$$F 6 ( C ) = min ( {\sum }_{i ∈ C} {I}_{i} , {\sum }_{j ∈ MatchSet ( C )} {R}_{j} ) * ( \frac{{\sum }_{j ∈ MatchSet ( C )} {P}_{j}}{{\sum }_{j ∈ MatchSet ( C )} {R}_{j}} )$$

$$min ( 200 , 350 ) * ( \$ ( 150 \text{/} 350 ) ) = \$85 .71$$

Another example objective function F7 is configured to compute best impression opportunities by filling the more lucrative opportunities first. The definition and example computation for F7 are as follows:

min(200,50)*$1+min(150,300)*$0.33=$100

Another example objective function F8 is similar to F3, but computes an average CPI (cost per impression) over the whole cluster. The definition and example computation for F8 are as follows:

$$F 8 ( C ) = {\sum }_{i ∈ C} {I}_{i} * ( \frac{{\sum }_{j ∈ MatchSet ( C )} {P}_{j}}{{\sum }_{j ∈ MatchSet ( C )} {R}_{j}} )$$

$$200 * ( \$ ( 150 \text{/} 350 ) ) = \$85 .71$$

Each of the example objective functions F4 to F8 can be suitably employed in one or more embodiments. It is noted, though, the example objective functions F4 to F8 may not strictly adhere to some of the criteria for a suitable objective function set forth above.

Consider now a detailed analysis of the first example objective function F introduced above. F does adhere to the criteria for a suitable objective function set forth above and accordingly can produce good results when used for inventory clustering techniques described herein.

As noted, an over estimate can be defined to compute the potential related to further dividing a child cluster. The over estimate can be defined as G of S(C)=Σ_{Lε{leaves under C}}F(L). Now for the objective function F it follows that:

$$F ( C ) = ( {\sum }_{i ∈ C} {I}_{i} ) * ( {\sum }_{j ∈ MatchSet ( C )} \frac{{P}_{j}}{{R}_{j}} )$$

$$G ( C ) = ( {\sum }_{i ∈ C} {I}_{i} ) * ( {\sum }_{j ∈ PotentialSet ( C )} \frac{{P}_{j}}{{R}_{j}} )$$

The cluster objective function F(C) of cluster C is the sum of how much money each advertiser that matches the known attributes of cluster C on all of the constraints can potentially make on each impression. The potential function G (C) of a cluster C is the sum of how much money each advertiser that matches the known attributes of cluster C can potentially make on each impression.

Consider the following example:

| | |
|---|---|
| let invs = [\| InventoryType(0, [\|0;1\|], 1); | // id, attribs, imps |
| InventoryType(1, [\|1;1\|], 2); | |
| InventoryType(2, [\|1;0\|], 2); \|] | |
| let advs = [\| AdvertiserType(0, [\|0;1\|], 1.0, 1); | // id, attribs, price, imps |
| AdvertiserType(1, [\|1; 0\|], 3.0, 1); \|] | |

In the above example, there are 3 distinct inventory types with respect to attribute values designated by 01, 11, and 10. The distinct inventory types have 1, 2, and 2 impressions, respectively. There are 2 advertisers with identifiers 0 and 1. Advertiser 0 designates that the second attribute to be set to 1. Advertiser 1 designates that the first attribute to be set to 1. The advertisers each have 1 impression, and respective prices $1 and $3.

Running the inventory clustering analysis completely to the end without pruning yields:

```
XX: Split: 0, Pot: 20.00, Actual: 15.00 Matched: 0.00, Missed: 20.00, Inv: [0,1,2], Adv Missed:[0,1]
  0X: Split: 1, Pot: 1.00, Actual: 1.00 Matched: 0.00, Missed: 1.00, Inv: [0], Adv Missed:[0]
    00: Leaf Pot: 0.00, Actual: 0.00 Matched: 0.00, Missed: 0.00, Inv: ---
    01: Leaf Pot: 1.00, Actual: 1.00 Matched: 1.00, Missed: 0.00, Inv: [0], Adv Matched:[0]
  1X: Split: 1, Pot: 16.00, Actual: 14.00 Matched: 12.00, Missed: 4.00,
Inv: [2,1], Adv Matched:[1], Adv Missed:[0]
    10: Leaf Pot: 6.00, Actual: 6.00 Matched: 6.00, Missed: 0.00, Inv: [2], Adv Matched:[1]
    11: Leaf Pot: 8.00, Actual: 8.00 Matched: 8.00, Missed: 0.00, Inv: [1], Adv Matched:[0,1]
```

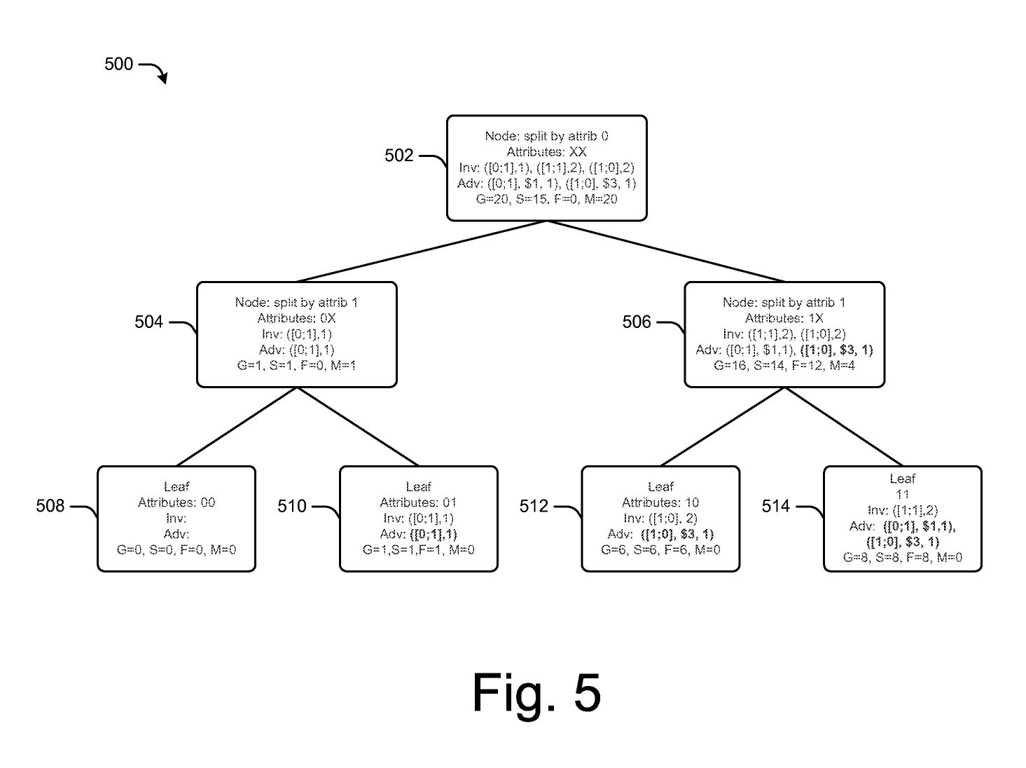

More graphically this example is depicted in FIG. 5. In particular, FIG. 5 depicts generally at 500 another example cluster graph corresponding to the preceding example. An initial cluster 502 is illustrated that has attribute values XX. The initial cluster 502 is divided into a cluster 504 designated by attribute values 0X and a cluster 506 designated by attribute values 1X. The cluster 504 and cluster 506 are each illustrated as being further divided in a like manner into additional sub-clusters including cluster 508 having attributes 00 and cluster 510 having attributes 01 under cluster 504, and cluster 512 having attributes 10 and cluster 514 having attributes 11 under cluster 506.

Here are some observations to consider when looking at the tree illustrated in FIG. 5 that is formed in this example:
The initial cluster 502 contains all the inventories and all the advertisers.
Each child cluster divides inventory and advertiser according to 1 attribute.
Inventories have no wild cards. They can only end up in one leaf.
Advertisers have wild cards (a value of 0 means that the attribute is unconstrained). They can appear in multiple leaves (e.g., advertiser [1,0] appears at the leaf 10 and the leaf 11).
S is the function to be optimized. It is computed bottom up from the leaves.
G is an over estimate of S. It is computed top down. G decreases with each split.
F is the value that can be extracted at child cluster assuming no further split is performed. At the leaves, F=S. Note that F evaluated for a parent is less than or equal to F evaluated for its children, meaning that dividing a cluster extracts more value.
M is the difference G−F. It is the maximum value that can be extracted by further dividing a cluster.

Clearly, two advertisers cannot use the same impressions (double counting advertiser impressions) and two inventories in different clusters cannot be used for the same advertiser order (double counting inventories). However, the goal for clustering can be to increase the “potential” for display in a cluster for each advertiser. Double counting can apply to revenue calculations, but this double counting may not matter when measuring display potential. The idea is to maximize display potential to derive suitable clusters and hence “double counting” is okay. This is also true for double counting impressions to obtain a maximum number of advertisers eligible to be displayed in that inventory and for double counting advertiser orders to allow each order to match a maximum number of inventory. Once a suitable set of clusters is formed, linear programming techniques and or other traditional techniques can be employed to compute an allocation and at this point the cases of double counting can be removed.

The potential function G (C) can be evaluated top down efficiently after computing the sum of inventories and the sum of advertisers Pⱼ/Rⱼ. Each time a cluster is subdivided, only a few advertisers are removed from the cluster and correspondingly few subtractions can be used to update the sum of Pⱼ/Rⱼ. The potential function G(C) is an over estimate of the objective function S(C)=Σ_{Lε{leaves under C}}F(L) because G(C) measures S(C) assuming the advertisers reach the leaves. G(C) decreases with each division of a cluster to form child clusters.

Now, if a cluster C is divided into two clusters C_{A} and C_{B}, it holds that:

F(C)≦F(C_{A})+F(C_{B})

This is because MatchSet(C_{A})=MatchSet(C)+{new matches in C_{A}} since splitting an attribute of cluster C increases the number of advertisers that match the new inventory. This is true of C_{B} as well. A proof that splitting C into two clusters C_{A} and C_{B} increases the sum of KnownMatches functions can be written as:

$$F ( {C}_{A} ) + F ( {C}_{B} ) = ( {\sum }_{i ∈ A} {I}_{i} + {\sum }_{i ∈ B} {I}_{i} ) * ( {\sum }_{j ∈ MatchSet ( C )} \frac{{P}_{j}}{{R}_{j}} ) + ( {\sum }_{i ∈ A} {I}_{i} ) * ( {\sum }_{j ∈ MatchSet ( {C}_{A} ) - MatchSet ( C )} \frac{{P}_{j}}{{R}_{j}} ) + ( {\sum }_{i ∈ B} {I}_{i} ) * ( {\sum }_{j ∈ MatchSet ( {C}_{B} ) - MatchSet ( C )} \frac{{P}_{j}}{{R}_{j}} ) \geq ( {\sum }_{i ∈ A} {I}_{i} + {\sum }_{i ∈ B} {I}_{i} ) * ( {\sum }_{j ∈ MatchSet ( C )} \frac{{P}_{j}}{{R}_{j}} ) = F ( C )$$

Equality exists if F(C_{A})=F(C) and F(C_{B})=F(C). Obviously, there is no benefit in dividing cluster C if that is the case.

When dividing a cluster, a cluster having the largest potential function G (C) is identified. However, within a cluster there can be advertiser orders that will be satisfied regardless of whether the cluster is expanded or not. The decision to divide the cluster can be based on how much advertiser value can be unlocked by forming more clusters. To reflect this, consider the general objective function:

M(C)=G(C)−F(C)

The value M that is measured according to the above objective function gets smaller and more accurate as more attribute constraints are added at each division. This is true because advertisers for which the designated constraints have been satisfied are removed from M(C). It is straightforward to count constraints that are satisfied for advertisers at each cluster division. When constraints of an advertiser have been satisfied, the advertiser no longer contributes to M(C). As a result M(C) can be computed effectively top down.

An example algorithm to compute the inventory clustering can be expressed as follows:

### Function SplitAttribute(InventorySet, AdvertiserSet, Threshold):

If M(InventorySet, AdvertiserSet)>Threshold then:
   Pick an attribute.
   For each possible value of attribute do:
      Filter InventorySet by attribute value
      Filter AdvertiserSet by attribute value
      Recursively call SplitAttribute(Filtered InventorySet, Filtered AdvertiserSet, Threshold)
   Return a node with results of recursive calls as children.
Else:
   Return a leaf node with InventorySet, Advertiser Set

The foregoing algorithm can be implemented using various different thresholds, as illustrated in the following examples:

```
Threshold = 0.:
XX: Split: 0, Pot: 20.00, Actual: 15.00 Matched: 0.00, Missed: 20.00, Inv: [0,1,2], Adv Missed:[0,1]
  0X: Split: 1, Pot: 1.00, Actual: 1.00 Matched: 0.00, Missed: 1.00, Inv: [0], Adv Missed:[0]
    00: Leaf Pot: 0.00, Actual: 0.00 Matched: 0.00, Missed: 0.00, Inv: ---
    01: Leaf Pot: 1.00, Actual: 1.00 Matched: 1.00, Missed: 0.00, Inv: [0], Adv Matched:[0]
  1X: Split: 1, Pot: 16.00, Actual: 14.00 Matched: 12.00, Missed: 4.00,
Inv: [2,1], Adv Matched:[1], Adv Missed:[0]
    10: Leaf Pot: 6.00, Actual: 6.00 Matched: 6.00, Missed: 0.00, Inv: [2], Adv Matched:[1]
    11: Leaf Pot: 8.00, Actual: 8.00 Matched: 8.00, Missed: 0.00, Inv: [1], Adv Matched:[0,1]
Threshold = 4.:
XX: Split: 0, Pot: 20.00, Actual: 14.00 Matched: 0.00, Missed: 20.00, Inv: [0,1,2], Adv Missed:[0,1]
  0X: Leaf Pot: 1.00, Actual: 0.00 Matched: 0.00, Missed: 1.00, Inv: [0], Adv Missed:[0]
  1X: Split: 1, Pot: 16.00, Actual: 14.00 Matched: 12.00, Missed: 4.00,
Inv: [2,1], Adv Matched:[1], Adv Missed:[0]
    10: Leaf Pot: 6.00, Actual: 6.00 Matched: 6.00, Missed: 0.00, Inv: [2], Adv Matched:[1]
    11: Leaf Pot: 8.00, Actual: 8.00 Matched: 8.00, Missed: 0.00, Inv: [1], Adv Matched:[0,1]
Threshold = 2.:
XX: Split: 0, Pot: 20.00, Actual: 12.00 Matched: 0.00, Missed: 20.00, Inv: [0,1,2], Adv Missed:[0,1]
  0X: Leaf Pot: 1.00, Actual: 0.00 Matched: 0.00, Missed: 1.00, Inv: [0], Adv Missed:[0]
  1X: Leaf Pot: 16.00, Actual: 12.00 Matched: 12.00, Missed: 4.00,
Inv: [2,1], Adv Matched:[1], Adv Missed:[0]
```

A threshold of 0 yields the complete tree with 3 non-empty leaves and the maximum display opportunity of 15. A threshold of 4 yields 2 non-empty leaves and a display opportunity of 14. A threshold of 2 yields 1 non-empty leaf and a display opportunity of 12. In the last case, advertiser 0 has no display opportunity.

### Attribute Splitting

The sequence in which the attributes are employed for clustering has an impact on performance of the clustering and the clusters that are formed. Clearly, it is computational expensive and time consuming to expand each child cluster recursively with respect to every possible attribute permutations. Careful attribute selection can be employed to maximize the chances of efficiently clustering down the line.

In at least some embodiments, attributes can be selected randomly. Additionally or alternatively, attributes can be pre-ranked according to a predefined and/or configurable list of rankings. Attributes can then be selected by applying these pre-rankings each time a parent cluster is divided.

Still further, a heuristic can be defined that enables weighting of attributes dynamically each time a parent cluster is divided. The heuristic can be dynamically calculated as clustering is being performed. The attribute weighting can be based at least in part upon an estimate of potential advertiser revenue corresponding to each attribute.

In at least some embodiments the heuristic is defined to take into account a combination of (1) a probability estimate of increase for the performance metric computed by the objective function that is expected for the child clusters and branches formed by resolving a potential attribute, and (2) an estimate of inventory separation that results if child cluster are formed based on the potential attribute.

The probability estimate can be computed by counting the constraints that get resolved for each attribute and weighting them by a price per impression. This produces a bunch of weighted attributes that can be used to obtain a sorted list. The list is then examined to identify an attribute that splits the inventory by at least a configurable percentage. The percentage value is configured to ensure that the split between clusters is balanced. For instance, the percentage value can ensure that at least some defined percentage of inventory of a parent (e.g., 10%, 25%, 30%, etc.) is placed into each child cluster. Without this constraint, a situation can occur in which a large number of clusters are computed that have little or no value.

To illustrate, assume there are 1000 advertiser orders for a child cluster, with constraints on 300 attributes, and that there are only distinct types of inventory left. The two type of inventory may have over 150 attributes in common. Additional clusters can be derived by resolving various attributes and sorting out the few advertisers that get removed at each division. If the two types of inventory are not separated, though, this merely produces a long string of child clusters with most having no available inventory and one child cluster having the two types of inventory that are available. This has little value and dramatically slows down computation. Thus, the second constraint is configured to ensure that inventory clustering produces clusters that are balanced.

The sorted list of weighted attributes that is obtained using the heuristic described above can be employed to select a sequence in which attributes are employed for the purpose of clustering. In particular, an attribute can be selected by determining an attribute of the sorted list that satisfies the percentage value constraint and has the highest relative weighting.

Applying this to the example described above, notice that at the initial cluster 502:
Attribute 0: 1 constraints of $3
Attribute 1: 1 constraints of $1

Therefore, attribute 0 has the most potential and is selected as the first attribute to be resolved. Accordingly, the described heuristic approach pushes attributes having relatively lower potential to the bottom of the tree, where they can be pruned.

In at least some embodiments, objective functions can be evaluated at least in part based upon computational complexity. In one example, objective functions are configured such that computational complexity is proportional to:

$${N}_{cluster} * ( {M}_{adv} * \frac{{C}_{av}}{{K}_{attrib}} + {K}_{attrib} )$$

Where N_{cluster} is the number of clusters, M_{adv} is the number of advertisers, Cₐᵥ is the average number of constraints per advertiser, and K_{attrib} is the number of attributes. This can occur by doing incremental book keeping of the F, G, and M for the advertisers from the top down.

Having described example implementation details regarding advertisement inventory matching, consider now an example system that can be employed to implement aspects of the described techniques.

### Example System

FIG. 6 illustrates generally at 600 an example computing device 602 that may implement the various embodiments described above. The computing device 602 may be, for example, a client 124 of FIG. 1, a server of a service provider 102, a server of an advertiser 120, or any other suitable computing device.

The computing device 602 includes one or more processors or processing units 604, one or more memory and/or storage components 606, one or more input/output (I/O) interfaces 608 for input/output (I/O) devices, and a bus 610 that allows the various components and devices to communicate one to another. The bus 610 represents one or more of several types of bus structures, including a memory bus or memory controller, a peripheral bus, an accelerated graphics port, and a processor or local bus using any of a variety of bus architectures. The bus 610 can include wired and/or wireless buses.

The memory/storage component 606 represents one or more computer storage media. The memory/storage component 606 may include volatile media (such as random access memory (RAM)) and/or nonvolatile media (such as read only memory (ROM), Flash memory, optical disks, magnetic disks, and so forth). The memory/storage component 606 may include fixed media (e.g., RAM, ROM, a fixed hard drive, etc.) as well as removable media (e.g., a Flash memory drive, a removable hard drive, an optical disk, and so forth).

The one or more input/output interfaces 608 allow a user to enter commands and information to computing device 600, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may comprise “computer-readable storage media.”

Software or program modules, including the inventory cluster tool 116, applications 108, service manager module 112, operating system 110, and other program modules, may be embodied as one or more instructions stored on computer-readable storage media. The computing device 602 may be configured to implement particular functions corresponding to the software or program modules stored on computer-readable storage media. Such instructions may be executable by one or more articles of manufacture (for example, one or more computing device 602, and/or processors 604) to implement techniques for inventory clustering, as well as other techniques. Such techniques include, but are not limited to, the example procedures described herein. Thus, computer-readable storage media may be configured to store instructions that, when executed by one or more devices described herein, cause various techniques for inventory clustering.

The computer-readable storage media includes volatile and non-volatile, removable and non-removable media implemented in a method or technology suitable for storage of information such as computer readable instructions, data structures, program modules, or other data. The computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or another tangible media or article of manufacture suitable to store the desired information and which may be accessed by a computer.

### CONCLUSION

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
placing an inventory of impressions to be divided into an initial cluster, the impressions used by a service provider to deliver advertising space in webpages to one or more advertisers;
recursively dividing the initial cluster according to selected attribute values for the impressions to derive child clusters;
measuring a cost associated with adding more clusters by further dividing the child clusters, the cost dependent upon a change in opportunities to match the advertisers to the impressions that results from the further dividing; and
forming additional clusters until the measured cost to add more clusters outweighs a benefit of adding more clusters.

2. The computer-implemented method of claim 1, wherein measuring the cost comprises optimizing an objective function of the form M(C)=G(C)−F(C), where G(C) for a cluster C measures opportunities to match advertisers to impressions associated with further dividing the cluster and F(C) evaluated at the cluster measures opportunities to match advertisers to impressions for the cluster in the absence of further dividing the cluster.

3. The computer-implemented method of claim 1, wherein the inventory is determined using a traffic model that represents data related to interaction of clients with the service provider to obtain resources made available by the service provider.

4. The computer-implemented method of claim 1, wherein recursively dividing the initial cluster comprises selecting an attribute and creating child clusters each corresponding to a subset of possible value of the attribute.

5. The computer-implemented method of claim 1, further comprising selectively dividing one or more of the child clusters based upon the measured cost of adding more clusters.

6. The computer-implemented method of claim 1, further comprising dividing the inventory into the one or more of the child clusters that are created such that inventory placed into a particular child cluster matches attribute values that are defined for the particular child cluster.

7. The computer-implemented method of claim 1, wherein measuring a cost associated with adding more clusters comprises optimizing an objective function configured to measure the cost.

8. The computer-implemented method of claim 7, wherein the objective function is defined to measure a revenue opportunity for a particular cluster, determine a potential revenue value assuming the particular cluster is divided into smaller clusters, and calculate a cost to divide the particular cluster as a difference between the determined potential revenue value and the measured revenue opportunity.

9. One or more computer-readable storage media storing instructions that, when executed by one or more server devices, cause the one or more server devices to implement an inventory cluster tool configured to:
identify a cluster having inventory to be divided, the inventory corresponding to impressions used by a service provider to deliver advertising space to advertisers;
select an attribute to divide the identified cluster;
form child clusters corresponding to the identified cluster based on the selected attribute; and
apply an objective function configured to determine whether to form more clusters.

10. One or more computer-readable storage media of claim 9, wherein the identified cluster is an initial cluster that is configured to contain an initial set of inventory to be processed and is un-constrained with respect to values for attributes of the inventory.

11. One or more computer-readable storage media of claim 9, wherein the objective function has the form M(C)=G(C)−F(C), where G(C) for a cluster C measures a potential for a performance metric associated with further dividing the cluster and F(C) evaluated at the cluster measures the performance metric for the cluster in the absence of further dividing the cluster.

12. One or more computer-readable storage media of claim 9, wherein the objective function is configured to evaluate a difference between
$$G ( C ) = ( {\sum }_{i ∈ C} {I}_{i} ) * ( {\sum }_{j ∈ PotentialSet ( C )} \frac{{P}_{j}}{{R}_{j}} ) and$$
$$F ( C ) = ( {\sum }_{i ∈ C} {I}_{i} ) * ( {\sum }_{j ∈ MatchSet ( C )} \frac{{P}_{j}}{{R}_{j}} ) ,$$
where Pⱼ is a price of an order j in a cluster C, Rⱼ is a number of impressions requested for the order, and Iᵢ is a number of impression for inventory i.

13. One or more computer-readable storage media of claim 9, wherein the attribute is selected according to a heuristic configured to:
assign weights to attributes to form a sorted list of attributes; and
designate a percentage value that defines a percentage amount of inventory to be placed into each child cluster that is formed.

14. One or more computer-readable storage media of claim 9, wherein the inventory cluster tool is further configured to:
determine to form more clusters based on application of the objective function;
identify a target cluster having inventory to be divided;
select an attribute to divide the identified target cluster;
form child clusters of the identified target cluster based on the selected attribute; and
reapply the objective function configured to determine whether to form more clusters.

15. One or more computer-readable storage media of claim 9, wherein the inventory cluster tool is further configured to:
determine not to form more clusters based on application of the objective function;
output a set of cluster formed for the inventory; and
utilize the set of cluster to deliver advertising space related to the inventory to the advertisers.

16. A computing system comprising:
one or more processors; and
computer readable storage media having one or more modules stored thereon, that, when executed via the one or more processors, cause the computing system to perform acts including:
identifying a cluster having inventory to be divided, the inventory corresponding to impressions used by a service provider to deliver advertising space to advertisers;
selecting an attribute to divide the identified cluster;
forming child clusters of the identified cluster based on the selected attribute; and
applying an objective function configured to:
measure revenue opportunity for a target cluster;
determine a potential revenue assuming the target cluster is divided into smaller clusters,
calculate a cost to divide the target cluster as a difference between the determined potential revenue and the measured revenue opportunity; and
selectively determine whether to further divide the target cluster according to the calculated cost to divide the target cluster.

17. The computer system of claim 16, wherein to measure the revenue opportunity for the target cluster comprises evaluating for the target cluster
$$F ( C ) = ( {\sum }_{i ∈ C} {I}_{i} ) * ( {\sum }_{j ∈ MatchSet ( C )} \frac{{P}_{j}}{{R}_{j}} ) ,$$
where Pⱼ is a price of an order j in a cluster C, Rⱼ is a number of impressions requested for the order, and Iᵢ is a number of impression for inventory i.

18. The computer system of claim 17, wherein to determine the potential revenue for the target cluster comprises evaluating for the target cluster
$$G ( C ) = ( {\sum }_{i ∈ C} {I}_{i} ) * ( {\sum }_{j ∈ PotentialSet ( C )} \frac{{P}_{j}}{{R}_{j}} ) .$$

19. The computer system of claim 16, wherein to measure the revenue opportunity for the target cluster comprises evaluating for the target cluster
$$F ( C ) = min ( {\sum }_{i ∈ C} {I}_{i} , {\sum }_{j ∈ MatchSet ( C )} {R}_{j} ) * ( {\sum }_{j ∈ MatchSet ( C )} \frac{{P}_{j}}{{R}_{j}} ) ,$$
where Pⱼ is a price of an order j in a cluster C, Rⱼ is a number of impressions requested for the order, and Iᵢ is a number of impression for inventory i.

20. The computer system of claim 16, wherein the impressions are related to search queries conducted by clients using a search service provided via the service provider, the impressions used by the service provider to enable advertisers to place advertisements for presentation to the clients in conjunction with resources served to the clients in response to the search queries.
